(19) United States
(12) Patent Application Publication
(10) Pub. No.: US 2010/0015990 A1
(43) Pub. Date: Jan. 21, 2010

(54) Method of providing location data from mobile terminal to base station in network

(75) Inventor: Michael Gallagher, Southampton (GB)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Southhampton Hampshire (GB)

(21) Appl. No.: 11/988,727

(22) PCT Filed: Jul. 4, 2006
(86) PCT No.: PCT/GB2006/050186

§ 371 Date: Sep. 23, 2009

(30) Foreign Application Priority Data
Jul. 12, 2005 (GB) 0514187.4

(51) Int. Cl. H04W 24/00

(52) U.S. Cl. 455/456.1

(57) ABSTRACT

A location area unit is set for one or more mobile terminals. An update periodicity is allocated to each mobile terminal related to its set location area unit and an update of a location of the mobile terminal is sent to the network, each time the mobile terminal crosses a boundary from one location area unit to another.

### CROSS REFERENCE TO RELATED APPLICATIONS

This application is based on and hereby claims priority to United Kingdom Application No. 0514187.4 filed on Jul. 12, 2005, the contents of which are hereby incorporated by reference.

### BACKGROUND

Described below is a method of providing location data from a mobile terminal to a base station in a network.

Current networks treat all mobile devices the same, which is becoming less applicable as mobile network technologies move toward concurrent support of both voice-oriented and data-oriented devices. This approach is sub-optimal.

In a situation where a mobile device wants information which is location specific, the network first needs to know what the mobile device's location is.

### SUMMARY

The method of providing location data from a mobile terminal to a base station in a network includes setting a location area unit for one or more mobile terminals; allocating an update periodicity to each mobile terminal related to its set location area unit; and sending an update of a location of the mobile terminal to the network, each time the mobile terminal crosses a boundary from one location area unit to another.

The mobile reports an update in its location to the network with a regularity that is dependent upon boundaries which can be varied discretely, so that the network has enough information to page, or poll the mobile when required.

The update periodicity may be determined from any suitable criteria, but preferably, the update periodicity is determined from one of available power supply and average rate of receipt of data, either alone or in combination.

The network may set the update periodicity, but preferably, the mobile terminal sets its update periodicity.

Preferably, the location area unit is any location within a predetermined range of one or more base stations, or one or more sectors within a base station.

Preferably, the base station transmits a location area identifier containing a series of location sub-area identifiers.

The identifier may be specifically signalled to certain devices, but preferably, the location area identifier is broadcast.

Preferably, the mobile terminal indicates which boundary has been crossed by transmitting a location sub-area identifier to the network.

This method is applicable to any device requiring service from a network, such as environmental monitoring equipment, meter readers or similar, but preferably, the mobile terminal is one of a laptop, a personal digital assistant, or a mobile phone. These may incorporate other functionality.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram illustrating a number of different location area units for carrying out the method; and,

FIG. 2 is a timing diagram illustrating the relative update frequency of different devices based on the location area units of FIG. 1.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

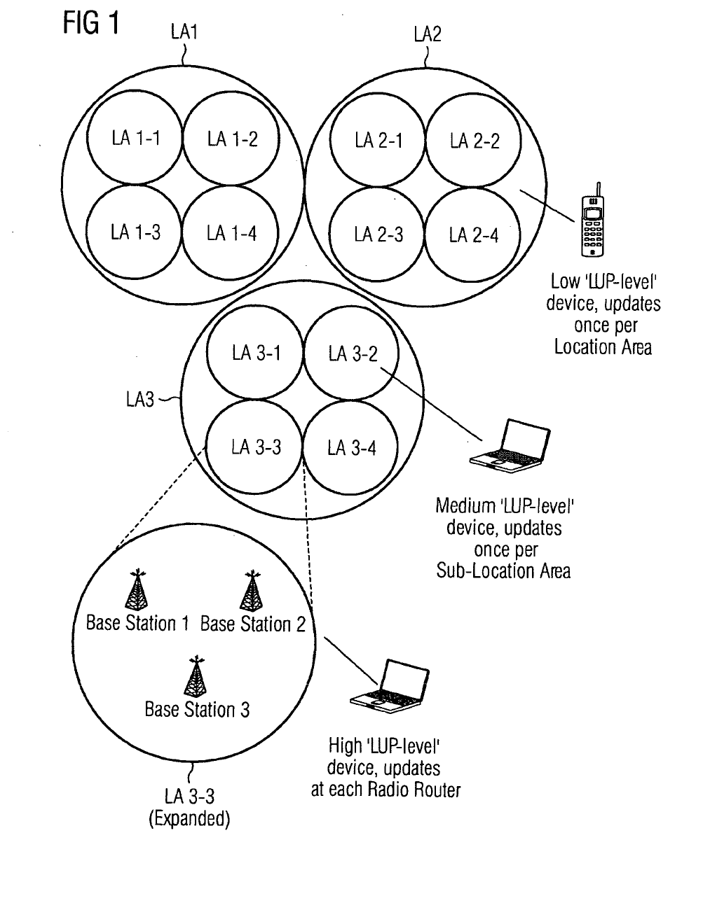

FIG. 1 illustrates a number of a neighbouring location areas LA1, LA2 and LA3. Each location area is divided into location sub-area, for example LA3-1, LA3-2, LA3-3 and LA3-4. Within one location sub-area LA3-3, there are a number of base stations, 1, 2, 3.

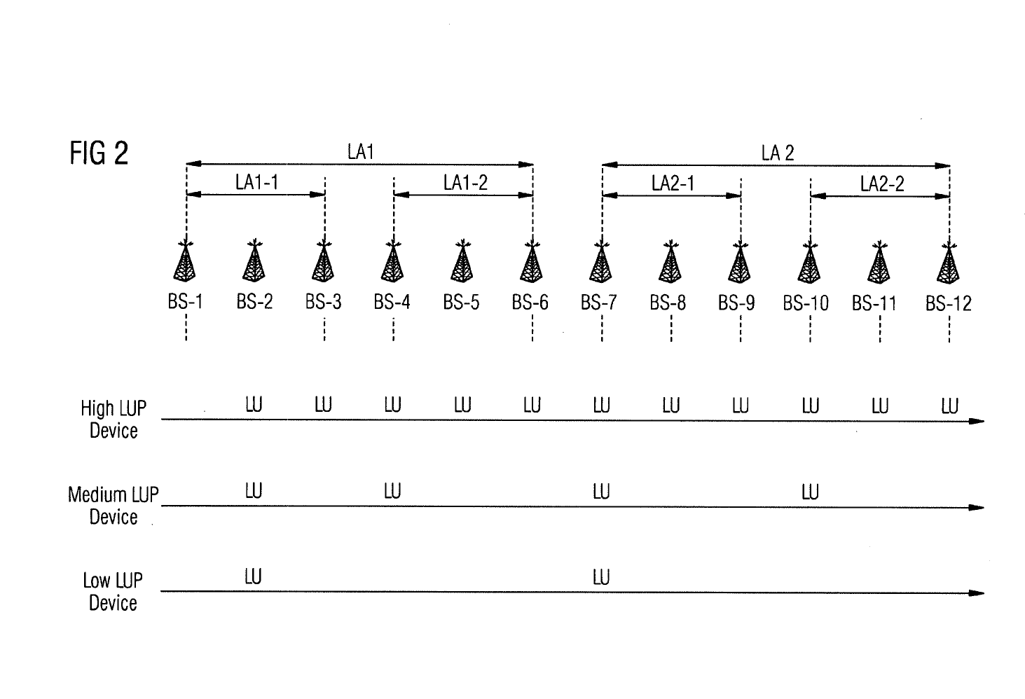

FIG. 2 illustrates this in a different form, showing that in a location area LA1, LA2 there are a number of base stations BS-1 to BS-6 and BS-7 to BS-12 respectively, whereas in a location sub-area e.g. LA1-1, the number of base stations present is fewer. In this example, there is only a subset of base stations BS-1 to BS-3 in LA1-1. The smallest unit for location updates is at each individual base station BS-1, BS-2, etc. The separation between updates will be determined by the number of base stations contained within the area of interest.

A device which is not particularly concerned with power usage, such as a laptop plugged into the mains may be categorized as a high location update periodicity device and is set a location area unit of a base station, i.e. on every change from one base station, or radio router, to the next, it must update its location to the network. This can be seen in FIG. 2 in the line labelled High LUP Device.

A device which is more concerned about power usage, such as a personal digital assistant, or a lap-top working from its own battery falls into the category of a medium location update periodicity device and is set a location area unit of a location sub-area LA3-2. Having performed a location update to the network within that unit, the device will only perform another location update when it crosses a boundary from one location sub-area to another. This can be seen in FIG. 2 on the line labelled Medium LUP Device. As it crosses the boundary into LA1-2, then LA2-1, then LA2-2, an update is performed, but not otherwise.

The final category in this example is a device which has severe power concerns, such as a mobile phone, which will be set a location update unit of a location area and so will only perform an update when it cross from LA1 to LA2. This is also illustrated by the line in FIG. 2, labelled Low LUP Device.

Thus, the method allows mobile terminals (MT) or mobile networks to adapt the frequency with which an MT performs location updates according to their circumstances. This is achieved through the introduction of a hierarchy of location areas. The actual control and allocation of the frequency may be done by either the mobile terminal itself or the network and as circumstances change, so can the applicable update frequency, e.g. if a lap-top loses its mains connection and switches to battery power, or if a mobile device receives a battery low indicator.

Amongst the advantages of the method are a reduction in air interface resources by allowing the possibility of paging for specific groups of MTs (such as laptop devices) across smaller location areas, down to the resolution of a single Base Station, or sector. This is achieved while simultaneously offering support for MTs traditionally associated with large location areas (e.g. mobile phones), which will continue to have to be paged over the larger area. Since both the smaller and larger location areas are superimposed upon one another, this allows multiple paging areas to be tailored to multiple classes of device, operating over the same geographical area.

The method has two parts, control of location-update periodicity (LUP), either by the mobile device or by the network and also the introduction of sub-location areas, so that different LUP levels can be realized

The frequency with which a MT performs a location update is controlled either by the MT itself, or by the network and depends upon a number of factors, such as the concern for power conservation of the MT, referred to here as the MTs ‘power-concern’ level, and the likelihood of downlink (DL) data arriving for a MT, for each base station it traverses, i.e. the likelihood of it being paged.

The location-update periodicity (LUP) level is a function of the determined factors, those of power and data rate being commonly of concern, although the LUP level can be set as a function of any factors deemed relevant for the particular application. The LUP is a measure of how often the MT should issue a Location Update. Several LUP levels may be defined, but three are introduced here by way of example in Table 1

TABLE 1
Location-Update Periodicity (LUP) Levels

| LUP | |
|---|---|
| Level | Qualifying Power & Paging Requirements |
| Low | High Power-Concern devices, receiving data infrequently |
| | (e.g. phones) |
| Medium | High Power-Concern devices, receiving data frequently |
| | (e.g. PDAs) |
| | Medium Power-Concern devices, receiving data infrequently |
| | (e.g. battery powered laptop) |
| High | Medium Power-Concern devices, receiving data frequently |
| | (e.g. battery powered laptop) |
| | Low Power-Concern devices (e.g. mains powered laptop) |

It can be seen that using the above factors, the LUP level takes into account the power-concern of the MT, and also the impact of the MT on air-link resources in terms of page requests. The LUP level, however, is not static, and can change depending on the power supply situation for each MT. For example, a laptop may be disconnected from the mains supply, and begin to run from battery power; or the same laptop may have very little remaining battery life, and consequently lower its LUP level. Thus, in most cases, it is the MT which determines its own LUP level, rather than the network. A disadvantage of network controlled LUP levels, is that if power levels on the MT are one of the factors in setting the LUP level, then additional signalling is required for the MT to indicate power levels to the network.

The realization of LUP level and its affect on location-update frequency is achieved though the introduction of a location area hierarchy. The network is separated into high level location areas, as in the case of a 3^{rd} Generation mobile phone network, for example, and also more granular sub-location areas. Different LUP levels can then be mapped onto different types of location area.

The location area hierarchy illustrated in FIG. 1 is just one example of how this can be arranged. In this example, low LUP-level devices perform a location update once per location area; medium LUP-level devices perform a location update once per location sub-area, and high LUP-level devices perform a location update at each base station that the device passes, or at each sector of the base station, if appropriate.

Each base station transmits a location area identifier, preferably over a broadcast channel, although other channel types could be used. For the example described above, the identifier format is:
<Location Area ID><Location Sub-Area ID><Base Station ID>

As the MT is performing a location update, it indicates the location boundary it updated in response to, i.e. the location area, location sub-area, or base station. This is used by a paging mechanism in the network to identify the area in which page-requests should be issued for the sleeping MT.

The location area hierarchy can have many levels and is not limited to the number indicated in the example above.

There are several advantages. The scheme allows a network to tailor the size of location areas to different classes of MT (or LUP level), and is achieved by introducing a location area hierarchy, containing location areas and location sub-areas. This results in the ability to target page requests to small areas for those MTs able to perform location updates more frequently, but also to target page requests over larger areas for those MTs able to perform location update less frequently, as is currently the case with mobile phones due to power consumption concerns. This saves air-link resources, since always having to page over single, large location areas is avoided.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69USPQ2d 1865 (Fed. Cir. 2004).

1-8. (canceled)

9. A method of providing location data from a mobile terminal to a base station in a network, comprising:
setting a location area unit for at least one mobile terminal;
allocating an update periodicity to each mobile terminal related to the location area unit set for that mobile terminal; and
sending an update of a location of the mobile terminal to the network, each time the mobile terminal crosses a boundary from one location area unit to another.

10. A method according to claim 9, wherein the update periodicity is determined based on at least one of available power supply and average rate of receipt of data.

11. A method according to claim 10, wherein the mobile terminal sets the update periodicity thereof.

12. A method according to claim 11, wherein the location area unit comprises any location within at least one sector of a base station, or within a predetermined range of at least one base station.

13. A method according to claim 12, wherein the base station transmits a location area identifier that includes a series of location sub-area identifiers.

14. A method according to claim 13, further comprising broadcasting the location area identifier.

15. A method according to claim 13, wherein the mobile terminal indicates which boundary has been crossed by transmitting a location sub-area identifier to the network.

16. A method according to claim 13, wherein the mobile terminal is one of a laptop, a personal digital assistant, and a mobile phone.
